(19) United States
(12) Patent Application Publication
(10) Pub. No.: US 2025/0155324 A1
(43) Pub. Date: May 15, 2025

(54) DEVICE FOR APPLYING FORCE TO A TEST OBJECT

(71) Applicant: Illinois Tool Works Inc., Glenview, IL (US)

(72) Inventors: Wolfgang BRENDEL, Modautal (DE); Alfred CLÜSSERATH, Roßdorf (DE); Burkhard BERTEMES, Darmstadt (DE); Gerald JUNG, Gadernheim (DE)

(21) Appl. No.: 18/943,297

(22) Filed: Nov. 11, 2024

(30) Foreign Application Priority Data
Nov. 14, 2023 (DE) 10 2023 131 735.0

(51) Int. Cl. G01M 17/007

(52) U.S. Cl. CPC G01M 17/007

(57) ABSTRACT

The present disclosure relates to an apparatus for introducing force into a test vehicle, wherein the apparatus comprises the following: a wheel adapter element, which is configured so as to be connected to a test vehicle; at least one first loading assembly for moving the wheel adapter element in a first, in particular translational, direction; a retaining apparatus, which is connected to the first loading assembly and configured so as to fix the first loading assembly in any position, in particular a working position, wherein the retaining apparatus is controllable independently of the first loading assembly.

### RELATED APPLICATIONS

The present application claims the benefit of German (DE) patent application Ser. No. 102023131735.0, filed Nov. 14, 2023. The entirety of German Patent Application No. 102023131735.0 is expressly incorporated herein by reference.

### FIELD OF THE DISCLOSURE

The present disclosure relates to an apparatus for introducing force into a test vehicle, in particular to simulate forces or torques introduced during driving operation in a motor vehicle or in parts of a motor vehicle.

### BACKGROUND

Driving dynamics, driving comfort, and driving safety are core elements in vehicle development. The chassis plays a key role in this. It has the task of supporting the vehicle mass, springing, damping vibrations and noises, compensating for external interference variables, bringing the drive torque onto the roadway, and bearing, guiding, steering, and braking the wheels. In addition to this variety of tasks, the chassis is also subjected to complex loads that the plurality of active and adaptive chassis components employed must also withstand. Increasing demands require continuous development and optimization of the chassis components, the body, and add-on parts in order to minimize the impact of roadway conditions, reduce weight and cost, and simultaneously increase lifetime and safety.

On the one hand, such influences on the chassis components can be checked by means of long-term tests (e.g., test drives). However, in order to simulate a lifecycle of a vehicle, it is necessary to test several hundred thousand kilometers of driving operation. This would require several months, even for continuous test drives. For the reasons mentioned above, “test benches” are used, which can replicate the forces and loads occurring in real driving operation as realistically as possible. Such test benches can simulate the forces and stresses occurring over several hundred thousand kilometers within a few days/weeks.

In general, at the end of an operational life-related quality assurance process, “test benches” serve to replicate the forces and loads that occur during real-world driving and that act on a vehicle to be tested or on parts of a vehicle to be tested as realistically as possible. For this purpose, real operating loads are tested after driving tests on axial and total vehicle test benches in order to draw conclusions about the effects of certain loads, in particular on the operational strength and oscillation behavior of the vehicle.

With such test benches, studies of chassis systems can be carried out under different driving states and roadway conditions, even at an early development stage, without relying on ready-to-drive total vehicles.

### SUMMARY

Devices for applying force to a test object are disclosed, substantially as illustrated by and described in connection with at least one of the figures, as set forth more completely in the claims.

### BRIEF DESCRIPTION OF THE DRAWINGS

FIG. 1 shows a schematic, perspective view of an apparatus for introducing force into a test vehicle according to an embodiment of the present disclosure;

FIG. 2 shows a cross-section through the perspective view of the first embodiment as shown in FIG. 1; and

FIG. 3 shows a lateral cross-section through the embodiment according to FIG. 1; and

FIG. 4 shows a schematic, perspective view of a part of the retaining apparatus according to an embodiment of the present disclosure.

### DETAILED DESCRIPTION

Test benches simulate the loads acting on the chassis, body, and add-on parts during driving operation. Vertical movements caused by roadway imperfections, forces, torques, and movements generated by vehicle maneuvers are modeled as realistically as possible. Environmental factors such as temperature and corrosive effects can also be simulated in parallel. Active and adaptive chassis components can be integrated synchronously into the test procedure via corresponding interfaces of the test bench electronics.

The test benches known from the prior art differ, in particular, in the manner in which forces are introduced into the chassis, the body, and add-on parts. Thus, a first category of test benches is based on platforms on which one respective tire of the test vehicle is mounted. The platforms can be moved in multiple degrees of freedom in order to simulate loads in road operation. Other test benches use conveyor belts or roller conveyors in order to simulate the travel movement. Finally, there are test benches having wheel adapter elements, which are movable in the space by a plurality of linear drives. The wheel adapter elements serve as a simulation of the vehicle wheels used in the real world and are connected to the chassis of the test vehicle during the test so that the forces introduced into the wheel adapter element can be transmitted directly to the chassis of the test vehicle.

In the case of known test benches having wheel adapter elements, it is possible to inadvertently deviate from a working position or any other position of the test benches. On the one hand, this can lead to damage to the test vehicle or the test bench itself. On the other hand, if the test vehicle and the test bench perform uncontrolled movements, there is an increased risk of injury.

Based on the aforementioned situation, the present disclosure addresses the problem of providing an apparatus for introducing force into a test vehicle, with which it can be ensured that unintended movement of the apparatus and in particular the wheel adapter element out of the working position (or any other position) is effectively prevented.

This problem is solved in particular by the subject matter of independent claim 1. Advantageous further developments of the apparatus according to the disclosure are specified in the dependent claims 2 to 10.

Accordingly, the present disclosure relates to an apparatus for introducing force into a test vehicle, wherein the apparatus comprises the following: a wheel adapter element configured so as to be connected to a test vehicle; at least one first loading assembly for moving the wheel adapter element in a first, in particular translational, direction; a retaining apparatus connected to the first loading assembly and configured so as to fix the first loading assembly in any position, in particular a working position, wherein the retaining apparatus is controllable independently of the first loading assembly.

The advantages of the apparatus according to the disclosure are self-evident. For example, with the novel retaining apparatus, it can be ensured that the loading assembly and the wheel adapter element connected thereto are movable only when the retaining apparatus is released. Because the retaining apparatus is configured separately from the loading assembly, i.e., it can be activated separately, a pressure drop in the loading assembly has no further consequences for the fixation of the retaining apparatus. That is to say, the loading assembly as well as the wheel adapter element continue to dwell in the selected parking position, for example the working position. The novel apparatus can achieve redundancy for the retention of the desired positions. On the one hand, the loading assembly and the wheel adapter element connected thereto can be held in the desired position by the actuators of the loading assembly. If a pressure drop occurs in the actuators of the loading assembly, the retaining apparatus can serve as additional safety, which is independently able to fix the loading assembly in place.

According to a further embodiment, the retaining apparatus is configured so as to gradually brake a movement of the first loading assembly until the first loading assembly rests in a desired position and is fixed by the retaining apparatus. Such a gradual braking of the movement of the first loading assembly reduces the load on the chassis of the test vehicle. In other words, the retaining apparatus in this embodiment is not configured as a fixed stop, which stops the movement of the loading assembly with immediate effect. Rather, the retaining apparatus incrementally reduces the movement of the first loading assembly over a determinable range of motion of the loading assembly until the loading assembly comes to a stop in the selected position.

According to a further embodiment, the retaining apparatus comprises a disk brake in order to gradually brake the movement of the loading assembly. A disk brake is a particularly stable and well-proven means for slowing mechanical movements and also to function as a parking brake or fixation apparatus.

The disk brake can comprise a brake disk or brake disk segment mounted on the first loading assembly. In other words, the movement of the first loading assembly results in corresponding movement of the brake disk segment in relation to a corresponding fixation element, such as brake shoes, of the disk brake. In alternative embodiments, the disk brake can also comprise a complete brake disk. The brake disk segment preferably extends over an angle that corresponds to the drive angle or pivot range of the first loading assembly.

According to a further embodiment, the first loading assembly comprises a lever element, in particular a single-arm lever, arranged between a first actuator and the wheel adapter element in order to move the wheel adapter element in the first direction, and wherein the brake disk is fixed on a pivot axis of the lever element. In other words, the lever element of this embodiment not only serves as a mechanical force transducer but is also suitable for moving the brake disk or brake disk segment in relation to the brake shoes.

According to a further embodiment, the first loading assembly comprises a transfer element, in particular a coupling rod, which is arranged between the lever element and the wheel adapter element. The transfer element is connected to the wheel adapter element such that it is movable in six degrees of freedom in relation to the lever element of the loading assembly in order to be able to simulate all roadway loads.

According to a further embodiment, the apparatus further comprises: a second loading assembly for moving the wheel adapter element in a second, in particular translational, direction, wherein the second direction extends substantially orthogonal to the first direction; a third loading assembly for moving the wheel adapter element in a third, in particular translational, direction, wherein the third direction extends substantially orthogonal to the first and second directions, wherein the transfer element of the first loading assembly is connected in an articulated manner to transfer elements of the second and third loading assemblies in a three-joint node.

According to this embodiment, the wheel adapter element can be moved in all three translational directions of movement. By connecting the first loading assembly to the second and third loading assemblies via the three-joint node, it is possible to prohibit the unwanted movements of the wheel adapter element in all directions of movement with only one retaining apparatus.

According to a further embodiment, the retaining apparatus comprises at least one fixation element for activating the retaining apparatus, wherein the fixation element is connected to a bracket of the retaining apparatus by means of at least one elastic buffer element. For example, the fixation element can be configured as a brake shoe of a brake disk assembly, as mentioned above. However, the fixation element can alternatively also be configured as a pin, which can be inserted into a corresponding perforated disk of the loading assembly in order to keep the loading assembly positively locked in the desired position. Regardless of how the fixation element is formed, the clastic buffer elements ensure a certain resiliency of the retaining apparatus. In other words, even in the parking position/working position of the loading assembly, a temporary movement, i.e., an elastic bump, is possible. This embodiment, as well as the gradual braking with the brake discs, prevents the loading assembly from stopping abruptly. Rather, with the elastic buffer elements, the loading assembly can be briefly moved beyond the selected parking/working position until the movement is completely picked up by the elastic buffer element and returned to the parking position.

According to a further embodiment, the fixation element is configured as a friction brake, wherein the retaining apparatus comprises a brake disk, which is configured so as to cooperate with the friction brake in order to fix the first loading assembly, wherein the at least one elastic buffer element is arranged such that the friction brake is movable in relation to the bracket at least in a plane parallel to the brake disk.

According to a further embodiment, the fixation element comprises brake shoes which are configured so as to cooperate with the brake disk in order to fix the first loading assembly. As already mentioned above, however, it is alternatively also possible to provide other fixation elements that are not based on the disk brake principle.

A further aspect of the present disclosure relates to a test bench for simulating forces and loads occurring during driving operation in a test vehicle, wherein the test bench comprises one of the preceding apparatuses per wheel of the test vehicle.

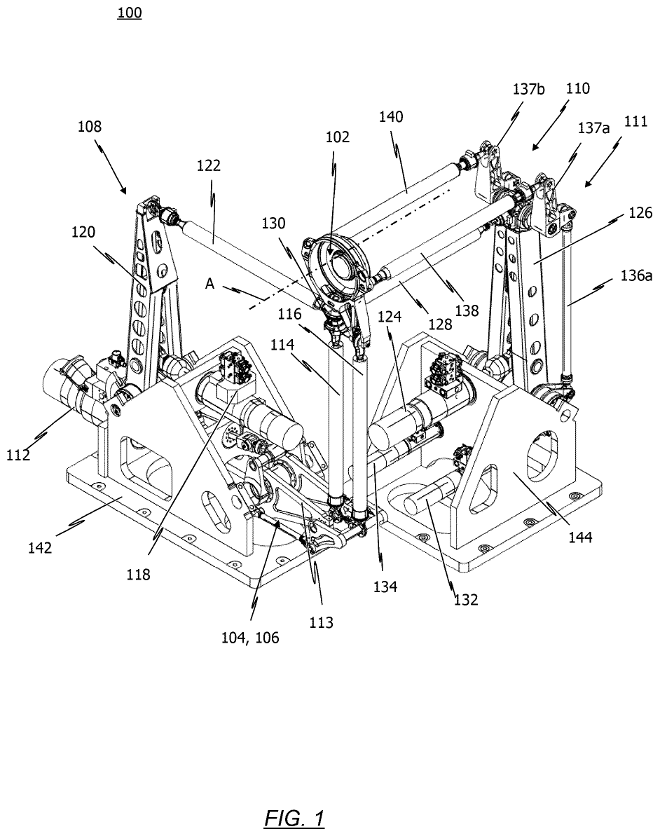

FIG. 1 is a perspective view of an apparatus for introducing force into a test vehicle according to an embodiment of the present disclosure. The apparatus 100 serves to move a wheel adapter element 102 in multiple degrees of freedom. In particular, the wheel adapter element 102 can be moved in six degrees of freedom by the apparatus 100.

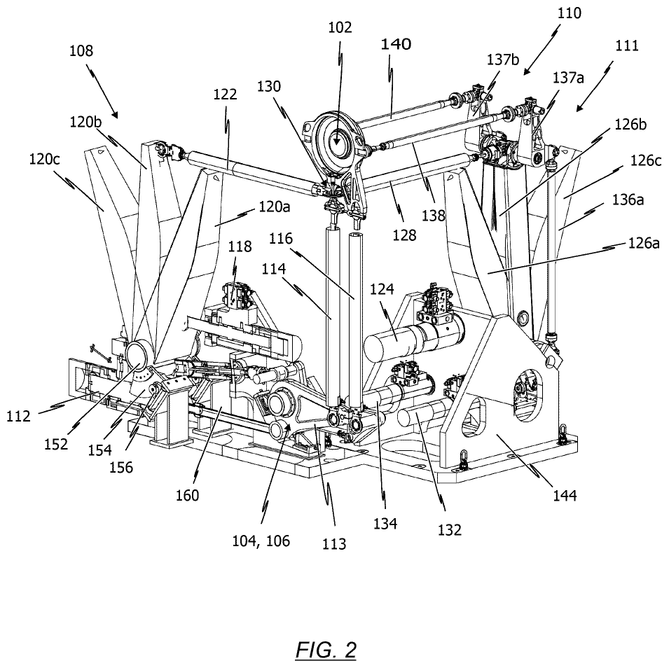

The apparatus 100 can be part of a test bench for simulating chassis loads while traveling. For example, such a test bench can contain four apparatuses according to FIG. 1, one apparatus per wheel of the test vehicle. In the following, only a single apparatus for introducing force is described on the basis of FIGS. 1 and 2. The function of the remaining apparatuses for introducing force is analogous. Of course, the activation of the actuators in the apparatus 100 of a test bench is synchronized with one another in order to create the desired load on the chassis of the test vehicle.

Although not shown in FIG. 1, when using the apparatus 100, the test vehicle is connected to the wheel adapter element 102. In particular, the chassis, for example the front or rear axis as well as the bumper, is connected to the wheel adapter element 102 prior to the start of the test.

The apparatus 100 comprises a first loading assembly 108 for moving the wheel adapter element 102 in a first translational direction. In the embodiment illustrated herein, the first direction is a longitudinal direction that runs parallel to the longitudinal axis of the test vehicle during operation.

The apparatus 100 further comprises a second loading assembly 104 for moving the wheel adapter element 102 in a second translational direction. In the embodiment shown herein, the second direction is the vertical direction. Accordingly, the second translational direction runs substantially perpendicular to the first direction.

A third loading assembly 110 of the apparatus 100 for introducing force into a test vehicle is used in order to move the wheel adapter element 102 in a third translational direction. In the exemplary embodiment shown herein, the third direction is a lateral direction of movement. The third direction runs substantially perpendicular to the first and second directions. In summary, the first, second, and third loading assemblies 108, 104, 110 ensure that the wheel adapter element 102 is movable in all three translational directions of movement.

The apparatus 100 comprises a fourth loading assembly for rotating the wheel adapter element 102. In particular, the fourth loading assembly 106 can be used in order to rotate the wheel adapter element about the wheel axis A and thereby simulate a braking force. The wheel axis A runs in particular parallel to the third direction. In the embodiment illustrated herein, the wheel axis A extends in the lateral direction.

The apparatus 100 further comprises a fifth loading assembly 111, which serves to introduce steering torques into the wheel adapter element 102. The steering torque is a rotation of the wheel adapter element 102 about a vertical axis (not shown) passing through the center point of the wheel adapter element 102 and intersecting the wheel axis A perpendicularly.

Also, by combining the third and fifth loading assemblies 110, 111, a pitching torque can be introduced into the wheel adapter element 102. A pitching torque is a rotation of the wheel adapter element 102 about a transverse axis that runs perpendicular to the wheel axis A and the vertical axis (not shown) and parallel to the longitudinal axis of the test vehicle.

In the embodiment shown herein, the first, second, and fourth loading assemblies 108, 104, 106 are attached to a first anchor 142. The third and fifth loading assemblies 110, 111 are attached to a second anchor 144. For example, the anchors 142, 144 can be attached to a bottom plate in order to discharge the counterforces occurring during the test.

Each of the loading assemblies 104, 106, 108, 110, 111 comprises at least one actuator 112, 118, 124, 132, 134, which is connected to the wheel adapter element 102 via a corresponding kinematics. The actuators 112, 118, 124, 132, 134 are all shown as linear drives. These can be configured as a hydraulic, electrical, or pneumatic linear drive. However, other types of actuators are contemplated.

The kinematics of each loading assembly 104, 106, 108, 110, 111 comprises at least one lever element that connects the actuator to a transfer element (here, with a coupling rod) 114, 116, 122, 128, 138, 140. The transfer elements themselves are each connected at a first end to a lever of the loading assembly and at an opposite second end to the wheel adapter element. The transfer elements configured as couplers are used in particular in order to transfer the movement of the actuator to the wheel adapter element 102.

The first loading assembly 108 comprises a first actuator 118, which is connected to a transfer element 122 configured as a coupling rod via a lever element 120. The lever element 120 is shown as a single-armed lever according to the embodiment shown herein, which can be pivoted by the drive rod of the first actuator 118 about a pivot axis 152 (FIG. 2). The transfer element 122 of the first loading assembly 108 is connected at a first end to a ball joint of a three-joint node 130. At an opposite second end, the transfer element 122 is connected in an articulated manner with a lever element 120.

At the position according to FIGS. 1 to 3, the transfer elements 114, 116, 122, 128, 138, 140 of the loading assemblies 104, 106, 108, 110, 111 are arranged orthogonally in relation to one another. This position is referred to as the working position. In the working position, at least the transfer elements 114, 122, 128 of the first, second, and third loading assemblies 104, 108, 110 are orthogonally aligned. The actuators 112, 118, 124 are each supported between their end positions (between a fully retracted position and a fully inserted position).

By contrast, in a resting position (not shown), at least the actuator 112 of the second loading assembly 104, i.e., the loading assembly for introducing vertical movement, is fully inserted. Accordingly, in the resting position, the wheel adapter element 102 is in its lower end position. In the resting position, the lever elements 120 and 126 as well as the associated transfer elements 122, 128 of the first and third loading assemblies 108, 110 are tilted downwards, as schematically shown by positions 120a and 126a.

Returning to the working position of the apparatus 100 as shown in FIG. 1, the transfer element 120 is aligned perpendicular to all remaining transfer elements 114, 116, 128, 138, 140. As indicated above, the first loading assembly 108 is used in order to input movements in the longitudinal direction via the transfer element 122 that is aligned parallel to the longitudinal direction of the test vehicle.

The second loading assembly 104 also comprises an actuator 112. The second actuator 112 is connected to a lever element 113 of the second loading assembly 104 via its drive rod. The lever element 113 is configured as an angle lever in this example. The drive rod of the second actuator 112 is connected at its distal end to a hinged joint of a first lever arm of the lever element 113. A second lever arm of the lever element 113 is connected via a hinged joint to a second end of the transfer element 114 of the second loading assembly 104.

The transfer element 114 of the second loading assembly 104 is arranged between the three-joint node 130 and the lever element 113. In the embodiment shown herein, the transfer element 114 of the second loading assembly is also configured as a coupler. A movement of the first actuator can be transmitted by the transfer element 114 of the second loading assembly 104 to the three-joint node 130 and the wheel adapter element 102 connected thereto. The second loading assembly 104 shown in FIG. 1 serves in particular for vertically moving the wheel adapter element 102.

The third loading assembly 110 comprises a third actuator 124 that is connected in an articulated manner with a transfer element 128 via a lever element 126. In the working position of the apparatus 100 as shown in FIGS. 1 and 2, the transfer element 128 is arranged orthogonally to the transfer elements 114, 116, 122 of the first, second, and fourth loading assemblies. At a first end, the transfer element 128 of the third loading assembly 110 is also connected to the ball joint of the three-node joint 130. At a second, opposite end, the transfer element 128 is connected to the lever element 126. The lever element 126 is also configured as a single-armed lever in the embodiment shown herein.

Finally, FIGS. 1 and 2 also show a fifth loading assembly 111. The fifth loading assembly 111 comprises a fifth actuator 132 and a sixth actuator 134. The fifth actuator 132 is connected to a lever element 137a via a transfer element 136a. For example, the lever element 137a is configured as an angle lever. A second end of the lever element 137a is connected to a second transfer element 138. The second transfer element 138 of the fifth loading assembly 111 connects the lever element 137a to an outer circumference of the wheel adapter element 102.

The sixth actuator 134 is connected to a lever element 137b via a third transfer element. For example, the lever element 137b is configured as an angle lever. A second end of the lever element 137b is connected to a fourth transfer element 140 of the fifth loading assembly. The fourth transfer element 140 of the fifth loading assembly 111 connects the lever element 137b to an outer circumference of the wheel adapter element 102.

The second and fourth transfer elements 138, 140 of the fifth loading assembly 111 run parallel to one another and parallel to the wheel axis A of the wheel adapter element 102. The two transfer elements 138, 140 are rod-shaped. The two transfer elements 138, 140 are each connected to the outer circumference of the wheel adapter element 102, in particular on diametrically opposed lateral faces of the wheel adapter element 102. Accordingly, by an opposite activation of the fifth and sixth actuators 132, 134 of the fifth loading assembly 111, a steering torque, that is to say a rotation about a vertical axis of the wheel adapter element 102, can be introduced into the wheel adapter element 102.

FIGS. 1 and 2 further illustrate that the three-joint node 130, in which the transfer elements 114, 122, 128 of the first, second, and third loading assemblies 104, 108, 110 are connected to one another, is arranged below the wheel element 102. The three-joint node 130 can accordingly be understood as a wheel mounting point of the wheel adapter element 102. The arrangement of the three-joint node 130 below the wheel adapter element 102 can simulate particularly realistic travel forces.

In operation, it is possible to introduce the aforementioned translational and rotational movements into the wheel adapter element 102 simultaneously and nevertheless independently of one another.

In FIG. 2, a perspective cross-section through the embodiment of the apparatus 100 shown in FIG. 1 is shown. In particular, FIG. 2 shows a cross-section through the first and second loading assemblies 108, 104. As mentioned above, the first loading assembly 108 serves in particular for moving the wheel adapter element 102 in the longitudinal direction of the test vehicle. For this purpose, a movement of the first actuator 118 is transferred to the lever element 120. The movement of the lever element 120 is ultimately transferred to the wheel adapter element 102 via the transfer element 122 configured as a coupling rod. The lever element 120 can be pivoted about the pivot axis 152, in particular.

In the illustration according to FIG. 2, three positions 120a, 120b, 120c of the lever element 120 are shown schematically. In a first position 120a, the lever element 120 is pivoted clockwise. As indicated above, position 120a can be the position of the lever element 120 in the resting position, i.e., the lower end position, of the apparatus 100. In a second position 120b, the lever element 120 is in the working position, i.e., the transfer elements 114, 122, 128 are orthogonally aligned with one another. In a third position 120c, the lever element 120 is pivoted counterclockwise. For example, this can be an upper end position of the apparatus 100 in which the actuator 112 of the second loading assembly 104 is fully retracted.

In FIG. 2, three positions 126a, 126b, 126c of the lever element 126 of the third loading assembly 110 are shown schematically. In a first position 126a, the lever element 126 is pivoted counterclockwise, i.e., towards the wheel adapter element 102. The position 126a can be the position of the lever element 126 when in the resting position, i.e., the lower end position, of the apparatus 100. In a second position 126b, the lever element 126 is in the working position, i.e., the transfer elements 114, 122, 128 are orthogonally aligned with one another. In a third position 126c, the lever element 126 is pivoted clockwise, i.e., away from the wheel adapter element. This can be an upper end position of the apparatus 100, in which the actuator 124 of the second loading assembly 104 is fully retracted.

The positions of the apparatus 100 and associated lever elements 120, 126 as described above are shown only schematically and incompletely. It should be noted that the apparatus is substantially continuously adjustable and thus can also take on any further position between the positions indicated in FIG. 2. The retaining apparatus 150 described below allows the apparatus 100 to be fixed in any position.

The pivot axis 152 of the lever element 120 of the first loading assembly 108 is connected to a brake disk segment 154. The brake disk segment 154 is part of a retaining apparatus 150, which is configured so as to fix the first loading assembly 108 in any position, for example in the working position 120b, 126b. For this purpose, the retaining apparatus 150 comprises a fixation element 156 configured as a friction brake. The fixation element serves to activate the retaining apparatus as soon as the loading assembly is in the desired position. For example, the fixation element 156 can be brake shoes that selectively contact/clamp the brake disk segment 154. It should be noted that the retaining apparatus can also be configured otherwise. For example, it is alternatively conceivable to not design the retaining apparatus as a disk brake in the sense of the embodiment of FIGS. 1 to 4, but rather to provide a perforated plate having a pin connector, for example.

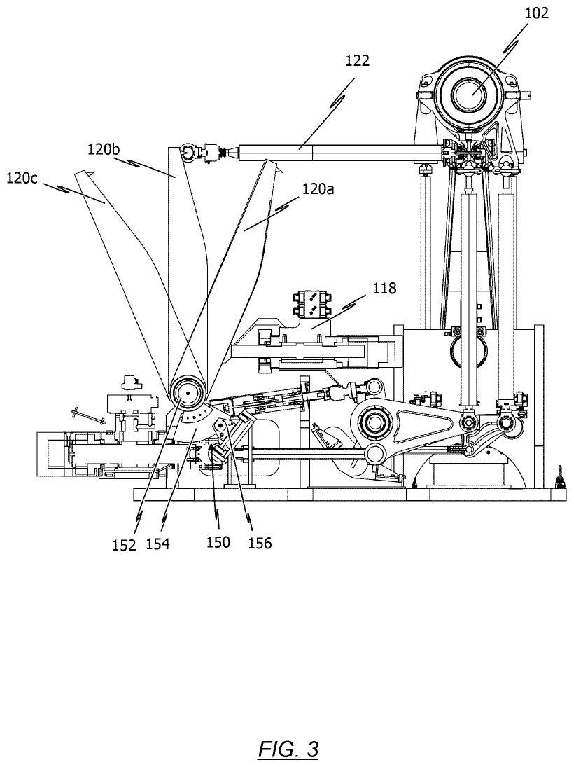

The retaining apparatus 150 (disk brake) as described in the embodiments is shown in detail in FIG. 3. In particular, it can be seen from FIG. 3 that the brake disk segment 154 is arranged on the pivot axis 152 of the lever element 120 in such a way that it can be brought into contact with the brake shoes 156 in any position 120a, 120b, 120c of the lever element 120, and thus in any position of the first loading assembly 108. In other words, a portion of the brake disk segment is at all times located between the brake shoes 156. For example, the position of the lever 120 or brake disk segment 154 as shown in FIG. 3 is the first position 120a. It should be noted that the disclosure is not limited to one brake disc segment. It can also be a brake disk that completely surrounds the pivot axis 152.

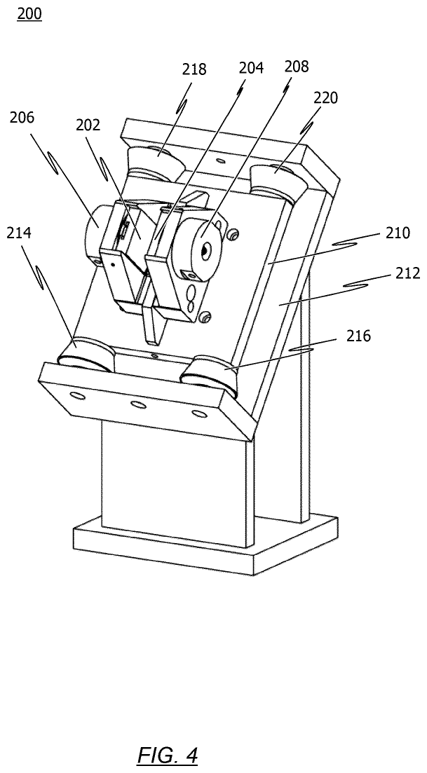

FIG. 4 is a schematic perspective view of a brake assembly 200. The brake assembly 200 supports the fixation element configured as a friction brake and attaches it, for example, to the anchor 142. The brake assembly 200 comprises a bracket 212 that is fixedly connected to the anchor 142 or the base plate. The brake assembly further comprises first and second brake shoes 202, 204, which are configured so as to selectively contact the brake disk segment 154.

The brake shoes 202, 204 can be moved by drive means 206, 208 in the manner known per se in order to produce a frictional force along with the brake disk segment 154.

The first and second brake shoes 202, 204 are arranged on a carrier plate 210. The carrier plate 210 is connected to the bracket 212 via clastic buffer elements 214, 216, 218, 220. The elastic buffer elements 214, 216, 218, 220 allow for a relative movement between the carrier plate 210 and the bracket 212. This results in particular in the brake shoes 202, 204 configured as friction brakes being movable in relation to the bracket 212, in a plane parallel to the brake disk segment 154. Accordingly, upon activation of the friction brake, there is initially an elastic deformation of the elastic buffer elements 214, 216 or the elastic buffer elements 218, 220, depending on the direction of rotation of the brake disk segment 154. The elastic buffer elements thus serve to allow for a gentle picking up of the movement of the loading assembly 108. This in particular protects the chassis of the test vehicle to be assessed.

Also, the retaining apparatus configured as a disk brake can be used in order to gradually decelerate the brake disk segment 154 and thus the first loading assembly 108, i.e., the brake shoes 202, 204 can initially transmit only a slight clamping force to the brake disk segment 154, which increases incrementally, until the brake disk segment and thus the first loading assembly 108 are in the desired position. As soon as the desired position of the loading assembly 108 is achieved, the brake shoes 202, 204 can act with full force on the brake disk segment 154, such that the loading assembly 108 is fixed in the desired position. It should be noted that the activation of the retaining apparatus occurs independently from the activation of the loading assembly 108. In particular, only an activation of the drive elements 206, 208 is necessary in order to activate the retaining apparatus. Thus, according to the disclosure, it is not necessary to subject the actuator 118 of the first loading assembly 108 to further pressure in order to maintain the desired position (for example, the working position). Rather, the load bearing assembly 108 can be held in the desired position solely by the retaining apparatus 150, so that damage to the chassis or possible injuries can be effectively prevented.

The present disclosure is not limited to the embodiments described in the drawings, but rather results from a combination of all of the features disclosed herein. It should be explicitly noted once again that the retaining apparatus of the present disclosure is not limited to disk brakes according to the embodiments described above. Rather, a fixation element having pins or similar selective stops can also be used in order to frictionally join the retaining apparatus to the loading assembly. Also in such an embodiment, it is preferred that elastic buffer elements are provided between the fixation element and a corresponding bracket of the retaining apparatus in order to prevent an abrupt stopping of the movement of the first loading assembly.

The embodiments only show one retaining apparatus for the first loading assembly 108. However, it is also possible to provide retaining apparatuses for any other loading assembly. In particular, it is contemplated that each of the three translational loading assemblies 104, 108, 110 are equipped with a separate retaining apparatus.

What is claimed is:

1. Apparatus for introducing force into a test vehicle, wherein the apparatus comprises:
a wheel adapter element configured so as to be connected to a test vehicle;
at least one first loading assembly for moving the wheel adapter element in a first direction; and
a retaining apparatus connected to the first loading assembly and configured so as to fix the first loading assembly in any position;
wherein the retaining apparatus is controllable independently of the first loading assembly.

2. The apparatus according to claim 1, wherein the retaining apparatus is configured so as to gradually brake movement of the first loading assembly until the first loading assembly rests in a desired position and is fixed by the retaining apparatus.

3. The apparatus according to claim 2, wherein the retaining apparatus comprises a disk brake in order to gradually brake the movement of the loading assembly.

4. The apparatus according to claim 3, wherein the disk brake comprises a brake disk or brake disk segment mounted on the first loading assembly.

5. The apparatus according to claim 4, wherein the first loading assembly comprises a lever element arranged between a first actuator and the wheel adapter element in order to move the wheel adapter element in the first direction, and wherein the brake disk or brake disk segment is fixed on a pivot axis of the lever element.

6. The apparatus according to claim 5, wherein the first loading assembly comprises a transfer element which is arranged between the lever element and the wheel adapter element.

7. The apparatus according to claim 6, wherein the apparatus further comprises:
a second loading assembly for moving the wheel adapter element in a second direction, wherein the second direction extends substantially orthogonal to the first direction; and
a third loading assembly for moving the wheel adapter element in a third direction, wherein the third direction extends substantially orthogonal to the first and second directions,
wherein the transfer element of the first loading assembly is connected in an articulated manner to transfer elements of the second and third loading assemblies in a three-joint node.

8. The apparatus according to claim 1, wherein the retaining apparatus comprises at least one fixation element for activating the retaining apparatus, wherein the fixation element is connected to a bracket of the retaining apparatus by at least one elastic buffer element.

9. The apparatus according to claim 8,
wherein the fixation element is configured as a friction brake and the retaining apparatus comprises a brake disk or a brake disk segment, which is configured so as to cooperate with the friction brake in order to fix the first loading assembly, and
wherein the at least one elastic buffer element is arranged such that the friction brake is movable in relation to the bracket at least in a plane parallel to the brake disk/brake disk segment.

10. The apparatus according to claim 9, wherein the fixation element comprises brake shoes, which are configured so as to cooperate with the brake disk or brake disk segment in order to fix the first loading assembly.

11. A test bench for simulating forces and loads occurring during driving operation in a test vehicle, wherein the test bench comprises one apparatus according to claim 1 for each wheel of the test vehicle.
